(19) United States
(12) Patent Application Publication
(10) Pub. No.: US 2015/0345658 A1
(43) Pub. Date: Dec. 3, 2015

(54) TAMPER RESISTANT FITTINGS

(71) Applicant: JB Industries, Inc.

(72) Inventors: David Madden, Aurora, IL (US); Scott Randall, Jupitor, FL (US); Gary Carpenter, St. Charles, IL (US)

(21) Appl. No.: 14/495,627

(22) Filed: Sep. 24, 2014

Related U.S. Application Data
(60) Provisional application No. 62/005,982, filed on May 30, 2014.

(51) Int. Cl. F16K 35/10

(52) U.S. Cl. CPC F16K 35/10

(57) ABSTRACT

Tamper resistant fittings for restricting access to valves, such as refrigerant valves and the like, are disclosed herein. In one embodiment, a tamper resistant fitting includes a cap having a threaded cavity to engage a valve. The cap can include a tamper resistant feature having one or more engagement features that can be engaged by a tool having a corresponding coupling feature. A sleeve can be coupled to the cap to prevent or at least deter access to the cap and/or to the engagement features. The tool can be used to threadably couple or uncouple the fitting with a valve.

### CROSS-REFERENCE TO RELATED APPLICATION INCORPORATED BY REFERENCE

The present application claims priority to U.S. Provisional Application No. 62/005,982, filed May 30, 2014, and entitled TAMPER RESISTANT FITTINGS, which is herein incorporated by reference in its entirety.

### TECHNICAL FIELD

The following disclosure relates generally to tamper resistant fittings and the like, and more particularly, to tamper resistant cap assemblies for refrigerant valves.

### BACKGROUND

Modern air conditioning and refrigeration systems employ a variety of refrigerants to provide cooling. With proper handling, most modern refrigerants are both safe and effective for their intended use. However, several of these refrigerants, e.g., Chlorofluorocarbons (CFCs, including Freon™) and Hydrochlorofluorocarbons (HCFCs), have the potential to cause environmental damage if released to the atmosphere. Additionally, the use of refrigerants as inhalants to produce a “high” can result in detrimental health effects to substance abusers. Furthermore, as a result of the relatively high cost of refrigerant, theft for resale or reuse is another concern for owners and/or operators of air conditioning and refrigeration systems.

Refrigerant systems often include easily accessible valves that provide for recharging and/or draining of the system. In many cases, a Schrader type valve with a threaded exterior and a central valve stem is provided. A simple screw-on cap is often threaded onto the valve to reduce the likelihood of an inadvertent release of refrigerant. However, simple screw-on caps can be readily removed by children who are unaware of the risks, or by substance abusers who disregard the risks. To minimize the inadvertent release of refrigerant to the atmosphere, and/or to reduce the ease of access to refrigerant by substance abusers, tamper resistant locks have been developed. However, these tamper resistant locks are often complicated and expensive to produce.

### BRIEF DESCRIPTION OF THE DRAWINGS

FIG. 1 is an exploded isometric view of a tamper resistant fitting configured in accordance with an embodiment of the present disclosure.

FIG. 2 is an isometric bottom view of a cap sleeve configured in accordance with an embodiment of the present disclosure.

FIG. 3 is a cross-sectional view of a cap configured in accordance with an embodiment of the present disclosure.

FIG. 4 is an isometric view of a tamper resistant fitting and a valve configured in accordance with an embodiment of the present disclosure.

### DETAILED DESCRIPTION

The following disclosure describes embodiments of tamper resistant fittings, such as tamper resistant caps and the like, for refrigerant systems. Some of the embodiments described below include features or advantages that overcome the limitations of existing tamper resistant devices. However, reference throughout this specification to features, advantages, or similar language does not imply that all of the features and advantages that may be realized with the present technology should be or are in any single embodiment of the present technology. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology. Additionally, in the following description of various embodiments of the present technology, numerous specific details are set forth in order to provide a thorough understanding of embodiments of the present technology. In other instances, well known components, methods and procedures have not been described so as not to unnecessarily obscure aspects of the embodiments of the present technology.

The features and advantages of the present technology will become more fully apparent from the following description, or may be learned by the practice of the present technology as set forth hereinafter. In order that the advantages of the present technology will be readily understood, a description of the present technology will be rendered by reference to specific embodiments that are illustrated in the appended drawings. Understanding that these drawings depict only typical embodiments of the present technology and are not therefore to be considered to be limiting of its scope, the present technology will be described and explained with reference to the accompanying drawings.

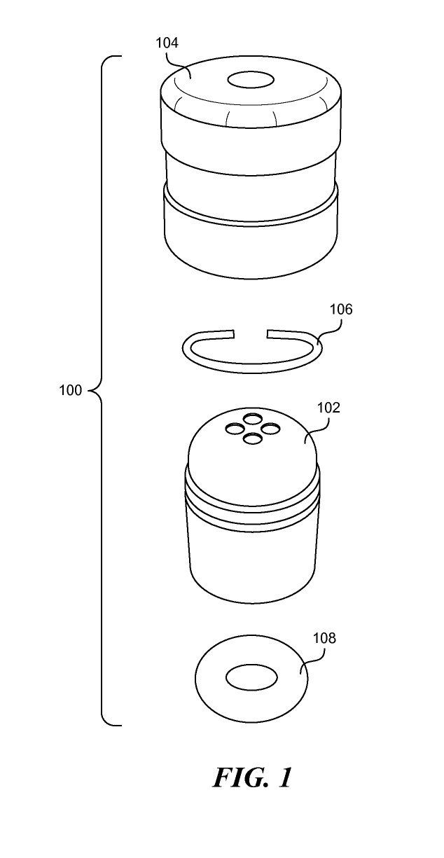

FIG. 1 is an exploded isometric view of a tamper resistant fitting 100 configured in accordance with an embodiment of the present disclosure. In the illustrated embodiment, the tamper resistant fitting 100 is a tamper resistant cap assembly for use with, for example, refrigerant systems. In other embodiments, the cap assemblies disclosed herein can be used with other pressurized fluid systems, such as propane systems, natural gas systems, etc. The tamper resistant fitting 100 (“fitting 100”) includes several components, including a cap 102, a cap sleeve or sleeve 104, a resilient retaining clip or clip 106 and a compressible O-ring or bumper 108. The components of the fitting 100 can be assembled in a variety of manners, as further described below. In general, however, the bumper 108 can be received within the cap 102, the clip 106 can be attached to the cap 102, and the sleeve 104 can be positioned over and rotatably coupled to the cap 102.

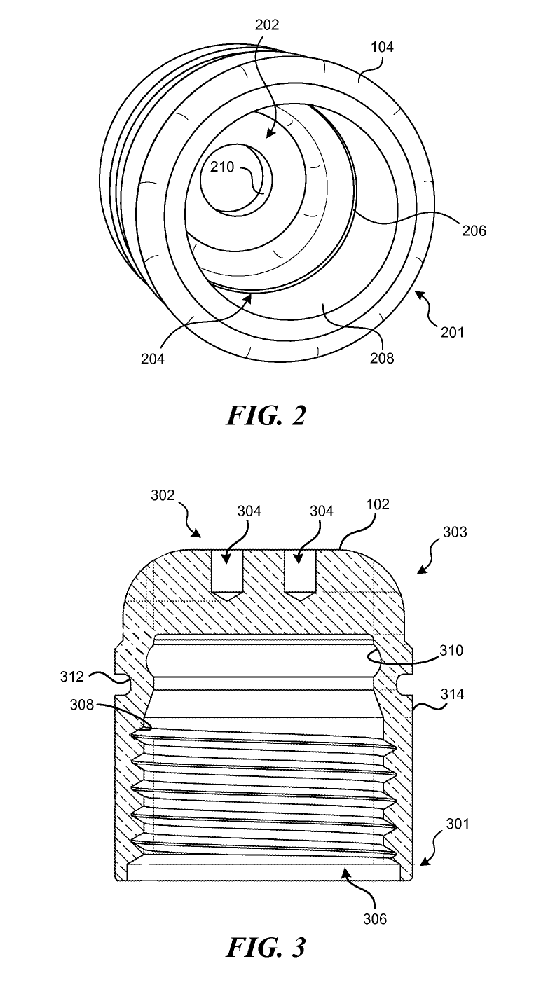

FIG. 2 is an isometric bottom view of the sleeve 104 configured in accordance with an embodiment of the present disclosure. In the illustrated embodiment, the sleeve 104 is an annular cylinder having a receiving cavity 204 extending from a proximal end 201 to an at least partially enclosed distal end 202. The sleeve 104 can be constructed from a variety of suitable materials including, for example, polyethylene, plastic, brass, metal, metal compounds or alloys, etc. In one aspect of this embodiment, the receiving cavity 204 can include a sleeve groove 206 in an inner wall 208 thereof for engaging the retaining clip 106 to rotatably couple the sleeve 104 to the cap 102, as further described below. The distal end 202 of the sleeve 104 includes an opening 210 positioned to receive a tool for attachment or removal of the fitting 100 to or from a valve, as further described below.

FIG. 3 is a cross-sectional view of the cap 102 configured in accordance with an embodiment of the present disclosure. Similar to the sleeve 104, the cap 102 can be constructed from a variety of suitable materials known in the art, e.g., brass, metal, metal compounds or alloys, plastic, polyethylene, etc. The cap 102 can include one or more tamper resistant features. For example, in the illustrated embodiment, the cap 102 includes a tamper resistant feature 302 having a plurality of engagement features. In the illustrated embodiment, the engagement features are blind holes 304. In some embodiments, four blind holes can be arranged in a square or star shaped pattern (as shown in FIG. 1). In other embodiments, the cap 102 can include at least two holes. In some embodiments, a tamper resistant feature can include a different pattern (e.g., circular, linear, triangular, etc.) and/or a different number of blind holes (e.g., two, three, five, etc.). In some embodiments, the blind holes 304 can have a diameter of 0.06 inches (1.5 mm) and can be spaced apart by 0.138 inches (3.5 mm). In other embodiments, the blind holes 304 can be larger or smaller than 0.06 inches and can be spaced apart by more or less than 0.138 inches.

In the illustrated embodiment of FIG. 3, the cap 102 is an annular cylinder having a closed distal end 303 and an open proximal end 301. The cap 102 includes a threaded cavity 306 extending from the proximal end 301 toward the distal end 303 and having a plurality of threads 308 to engage a valve (e.g., a refrigerant valve on an air conditioning system, not shown in FIG. 3). The threads 308 can be pipe threads or other threads as known in the art. The threaded cavity 306 includes an inner groove 310 positioned toward the distal end 303 and configured to receive the bumper 108 (FIG. 1), and an outer groove 312 positioned to receive the retaining clip 106 (FIG. 1).

In addition to blind holes, embodiments in accordance with the present technology can include alternative engagement features. For example, although the illustrated embodiment of FIG. 3 includes the blind holes 304, in some embodiments the tamper resistant feature 302 can include one or more holes that are not blind, and which extend into the threaded cavity 306. In such an embodiment, the distal end 303 would be at least partially open. Additionally, in several embodiments, the tamper resistant feature 302 can be a single engagement feature. For example, the cap 102 can include a single engagement feature that is shaped to receive a security hex socket or a security Torx bit. In several embodiments, the engagement features can be protrusions, slots, or other features that can be engaged by corresponding tools.

Referring to FIGS. 1-3 together, the tamper resistant fitting 100 can be assembled by inserting the bumper 108 into the inner groove 310 of the threaded cavity 306, and installing the retaining clip 106 in or at least partially within the outer groove 312. The inner groove 310 can retain the bumper 108 within an upper portion of the threaded cavity 306, and the outer groove 312 can retain the clip 106 on the cap 102. When the clip 106 is attached to the cap 102, at least a portion of the clip 106 can extend outwardly past an outer wall 314 of the cap 102 to engage the sleeve groove 206 when the sleeve 104 is coupled to the cap 102. The sleeve 104 can be pushed down over the cap 102 to receive at least a portion of the cap 102 within the receiving cavity 204. The inner wall 208 of the sleeve 104 can slide over the outer wall 314 of the cap 102 and can compress the retaining clip 106. As the sleeve 104 is pushed further onto the cap 102, the retaining clip 106 expands outwardly into the sleeve groove 206, rotatably coupling the sleeve 104 to the cap 102 to complete the assembly of the fitting 100.

When the sleeve 104 is rotatably coupled to the cap 102 to assemble the fitting 100, the opening 210 in the sleeve 104 is axially aligned with the tamper resistant feature 302 (e.g., the engagement features or holes 304) of the cap 102. Additionally, when the fitting 100 is assembled, the sleeve 104 can contain most or all of the cap 102 within the receiving cavity 204. In some embodiments, the assembled fitting 100 can have a length and a diameter that are both approximately 0.75 inches (19 mm). In other embodiments, the length and the diameter can be larger or smaller than 0.75 inches.

The assembly of the fitting 100 via the clip 106 can provide for rapid and efficient manufacturing that reduces costs. Specifically, the clip 106 can provide a robust coupling between the cap 102 and the sleeve 104, without requiring complicated components or time consuming and expensive manufacturing steps.

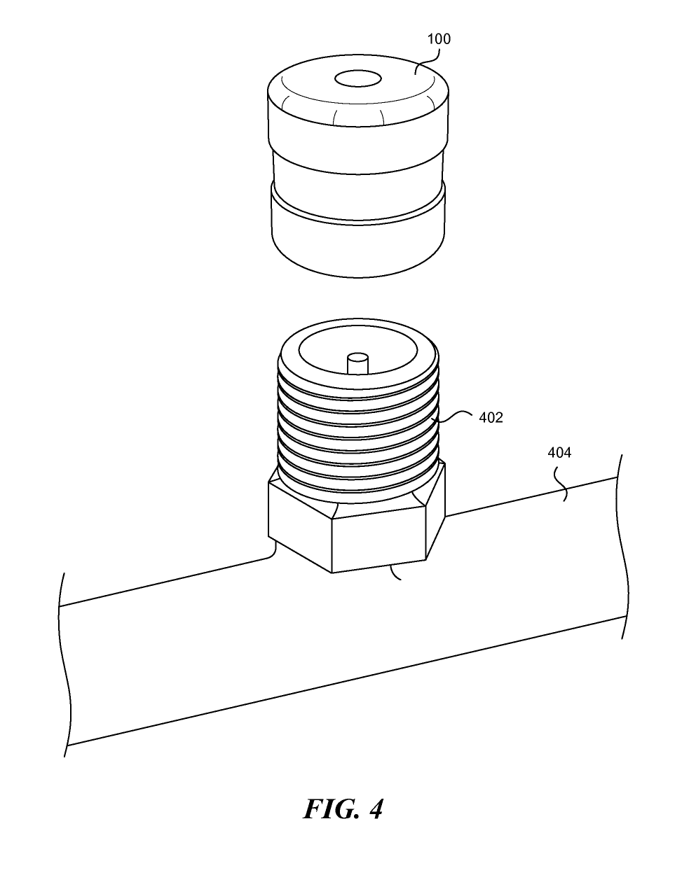

FIG. 4 is an isometric view of the fitting 100 and a valve 402 (e.g., a refrigerant valve) configured in accordance with an embodiment of the present technology. In the illustrated embodiment, the valve 402 is positioned in-line with a pipe 404. Referring to FIGS. 1-4, in operation, the fitting 100 can be positioned over the valve 402 and a tool (not shown) having one or more coupling features (e.g., prongs, a socket, a bit, etc.) that correspond to the tamper resistant feature 302 can be used to rotate and threadably couple the fitting 100 to the valve 402. In some embodiments, the tool can be a spanner wrench having prongs that can be inserted through the opening 210 in the sleeve 104 and into the engagement features or holes 304 to provide for the application of torque to the cap 102. For example, the tamper resistant feature 302 of the illustrated embodiment includes blind holes 304 that are sized and positioned to be engaged by, for example, a #6 spanner bit. The tool can rotate the cap 102 and threadably couple the fitting 100 to the valve 402. After the fitting 100 is sufficiently secured to the valve 402 (e.g., when the bumper 108 is compressed against the end of the valve), the tool can be removed from the opening 210.

When the fitting 100 is coupled to a valve (e.g., the valve 402), the distal end 202 of the sleeve 104 at least partially blocks access to the tamper resistant feature 302. Accordingly, torque cannot easily be applied to the cap 102 to disengage the fitting 100 from the valve. Hence, the tamper resistant fitting 100 can reduce improper access to refrigerant and/or inadvertent discharge of refrigerant. In several embodiments, the cap 102, the sleeve 104 and/or other components of the fitting 100 can be concentric in shape. The concentric shapes of the cap 102 and the sleeve 104 can aid in providing for rotation of the sleeve 104 without a corresponding rotation of the cap 102. For example, if a person attempts to access a valve by rotating the fitting 100 via the sleeve 104, the concentric sleeve 104 will rotate freely around the concentric cap 102.

To remove the fitting 100 from the valve 402, a technician, maintenance person, or other person performing maintenance or repair can insert an appropriate tool with one or more coupling features that correspond to the tamper resistant feature 302 through the opening 210 to apply torque to rotate the cap 102. For example, a wrench, driver, socket, bit, or other type of tool or tool attachment can include prongs that are configured to fit within the holes 304. Absent a tool that can engage the tamper resistant feature 302, a person cannot readily apply sufficient torque to the cap 102 to permit removal of the fitting 100 from the valve 402. Specifically, the sleeve 104 can contain the cap 102 within the receiving cavity 204 to minimize access to the cap 102 such that a person cannot readily apply torque to the outer wall 314 of the cap 102.

From the foregoing, it will be appreciated that specific embodiments of the present technology have been described herein for purposes of illustration, but that various modifications may be made without deviating from the spirit and scope of the various embodiments of the present technology. For example, the tamper resistant fittings disclosed herein can be constructed in various shapes, sizes and arrangements, and can include a variety of tamper resistant features. Accordingly, the invention is not limited except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A tamper resistant fitting for limiting access to a valve, the tamper resistant fitting including:
a cap having a tamper resistant feature toward a distal cap end and a threaded cavity extending from a proximal cap end toward the distal cap end;
a sleeve having a receiving cavity extending from a proximal sleeve end toward a distal sleeve end, the distal sleeve end having an opening into the receiving cavity, wherein at least a portion of the cap is positioned within the receiving cavity such that the opening at the distal sleeve end is axially aligned with the tamper resistant feature of the cap; and
a retaining clip positioned to rotatably couple the sleeve to the cap.

2. The tamper resistant fitting of claim 1 wherein the cap includes an outer wall having an outer groove, and wherein the retaining clip is positioned at least partially within the outer groove to rotatably couple the sleeve to the cap.

3. The tamper resistant fitting of claim 1 wherein the sleeve includes an inner wall having a sleeve groove, and wherein the retaining clip is positioned at least partially within the sleeve groove to rotatably couple the sleeve to the cap.

4. The tamper resistant fitting of claim 1 wherein the tamper resistant feature includes a plurality of blind holes.

5. The tamper resistant fitting of claim 4 wherein the plurality of blind holes comprises four blind holes arranged in a square pattern.

6. The tamper resistant fitting of claim 1 wherein the opening provides access to the tamper resistant feature.

7. The tamper resistant fitting of claim 1, further comprising an O-ring positioned at a distal end of the threaded cavity.

8. The tamper resistant fitting of claim 1 wherein the cap and the sleeve are annular cylinders, and wherein the sleeve is freely rotatable about the cap.

9. A tamper resistant fitting for securing valves, the tamper resistant fitting comprising:
a cylindrical cap extending from a cap proximal end to a cap distal end, the cap including:
an engagement feature positioned at the cap distal end;
a threaded cavity extending from the cap proximal end toward the cap distal end; and
an outer wall having an outer groove; and
a cylindrical sleeve extending from a sleeve proximal end to a sleeve distal end, the sleeve including:
an inner wall that at least partially defines a receiving cavity extending from the sleeve proximal end toward the sleeve distal end, wherein the sleeve is configured to receive at least a portion of the cap within the receiving cavity;
a sleeve groove extending along the inner wall; and
an opening in the distal end of the sleeve, wherein the opening extends into the receiving cavity, and wherein the opening is axially aligned with the engagement feature when the portion of the cap is received in the receiving cavity; and
a retaining clip positioned at least partially within the outer groove, wherein the retaining clip is configured to rotatably couple the cap and the sleeve via the outer groove and the sleeve groove when the portion of the cap is received in the receiving cavity.

10. The tamper resistant fitting of claim 9 wherein the engagement feature comprises a blind hole.

11. The tamper resistant fitting of claim 9 wherein the engagement feature is a first engagement feature, wherein the cap further includes a second engagement feature, and wherein the first engagement feature and the second engagement feature are positioned to receive a spanner bit.

12. The tamper resistant fitting of claim 9 wherein the engagement feature is a first engagement feature, wherein the cap further includes a second engagement feature, a third engagement feature, and a fourth engagement feature, and wherein the first, second, third and fourth engagement features comprise blind holes positioned to receive a spanner bit.

13. The tamper resistant fitting of claim 9 wherein the threaded cavity includes threads configured to engage a refrigerant valve.

14. The tamper resistant fitting of claim 9, further comprising a bumper positioned within the threaded cavity.

15. The tamper resistant fitting of claim 14 wherein the cap includes an inner groove positioned at a distal end of the threaded cavity, and wherein the bumper is positioned at least partially within the inner groove.

16. The tamper resistant fitting of claim 9 wherein the sleeve is configured to receive the entire cap within the receiving cavity.

17. A method for forming a tamper resistant fitting, the method comprising:
forming a cap, the cap having a threaded cavity extending from a cap proximal end toward a cap distal end and a tamper resistant feature at the cap distal cap end;
forming a sleeve having a receiving cavity extending from a sleeve proximal end toward a sleeve distal end;
forming an opening in the sleeve distal end;
attaching a clip to the cap; and
rotatably coupling the sleeve to the cap via the clip.

18. The method of claim 17 wherein rotatably coupling the sleeve to the cap includes positioning the cap entirely within the receiving cavity.

19. The method of claim 17 wherein attaching the clip to the cap includes positioning the clip within an outer groove on the cap.

20. The method of claim 19 wherein the sleeve includes a sleeve groove, and wherein rotatably coupling the sleeve to the cap includes positioning the clip within the sleeve groove.
